(19) United States
(12) Patent Application Publication
(10) Pub. No.: US 2017/0083146 A1
(43) Pub. Date: Mar. 23, 2017

(54) SELF-CAPACITIVE TOUCH OPERATION METHOD AND SELF-CAPACITIVE TOUCH SENSING APPARATUS

(71) Applicant: Raydium Semiconductor Corporation, Hsinchu (TW)

(72) Inventors: Chih Yuan, New Taipei City (TW); Chih-Hsiung Chen, New Taipei City (TW); Chen-Wei Yang, Hsinchu City (TW); Kun-Pei Lee, Zhunan Township (TW)

(21) Appl. No.: 15/268,830

(22) Filed: Sep. 19, 2016

Related U.S. Application Data
(60) Provisional application No. 62/222,233, filed on Sep. 23, 2015.

(51) Int. Cl. G06F 3/041; G06F 1/32; G06F 3/044

(52) U.S. Cl. CPC G06F 3/0416; G06F 3/044; G06F 1/3262

(57) ABSTRACT

A self-capacitive touch operation method and a self-capacitive touch sensing apparatus applied to a self-capacitive touch panel are disclosed. The self-capacitive touch operation method disposes program-controllable touch sensing nodes and selectively controls each touch sensing node to operate independently or combines at least two touch sensing nodes of the touch sensing nodes to operate together under different operation modes. The self-capacitive touch sensing apparatus includes program-controllable touch sensing nodes and a control module. Under different operation modes, the control module selectively controls each touch sensing node to operate independently or combines at least two touch sensing nodes of the touch sensing nodes to operate together.

### BACKGROUND OF THE INVENTION

1. Field of the Invention

This invention relates to capacitive touch sensing, especially to a self-capacitive touch operation method and a self-capacitive touch sensing apparatus.

2. Description of the Prior Art

In general, the conventional self-capacitive touch sensing method applied in the self-capacitive touch panel uses each touch sensing node as an independent sensing unit. Thus, the minimum sensing capacitance of each independent touch sensing node varies with different sensing area sizes of touch sensing node, different distances between the touch sensing node and the item to be detected and different kinds of medium.

However, since each touch sensing node performs touch sensing independently and the touch sensing node are numerous, the power consumption of touch sensing will be largely increased. In addition, when each touch sensing node performs touch sensing independently, once the touch signal is small signal (e.g., the user wears gloves to touch the self-capacitive touch panel), the touch signal strength sensed by one touch sensing node will be too small to distinguish from the noise; therefore, the signal-to-noise ratio (SNR) will be reduced and the self-capacitive touch sensing performance of the conventional self-capacitive touch panel will be also damaged.

### SUMMARY OF THE INVENTION

Therefore, the invention provides a self-capacitive touch operation method and a self-capacitive touch sensing apparatus to solve the above-mentioned problems.

An embodiment of the invention is a self-capacitive touch operation method. In this embodiment, the self-capacitive touch operation method is applied to a self-capacitive touch panel. The self-capacitive touch operation method includes the steps of disposing a plurality of program-controllable touch sensing nodes; and selectively controlling each of the plurality of touch sensing node to operate independently or combining at least two touch sensing nodes of the touch sensing nodes to operate together under different operation modes.

In an embodiment, the self-capacitive touch operation method further includes step of combining the at least two touch sensing nodes of the plurality of touch sensing nodes to perform touch sensing under a self-capacitive sensing mode to combine touch sensing signals of the at least two touch sensing nodes.

In an embodiment, if the touch sensing signals of the at least two touch sensing nodes are small signals, the touch sensing signals are combined as a combined touch sensing signal and then an analog-digital converter calculates a capacitance variation of the combined touch sensing signal to increase signal-to-noise ratio (SNR) and reduce power consumption.

In an embodiment, the self-capacitive touch operation method further includes a step of driving each of the plurality of touch sensing nodes independently under a self-capacitive driving mode.

In an embodiment, the self-capacitive touch operation method further includes a step of compensating each of the plurality of touch sensing nodes independently under a self-capacitive compensating mode.

In an embodiment, the self-capacitive touch panel is an in-cell touch panel, an on-cell touch panel or an out-cell touch panel.

Another embodiment of the invention is a self-capacitive touch sensing apparatus. In this embodiment, the self-capacitive touch sensing apparatus is applied to a self-capacitive touch panel. The self-capacitive touch sensing apparatus includes a plurality of program-controllable touch sensing nodes and a control module. The control module is coupled to the plurality of program-controllable touch sensing nodes. Under different operation modes, the control module selectively controls each of the plurality of touch sensing nodes to operate independently or combines at least two touch sensing nodes of the plurality of touch sensing nodes to operate together.

Compared to the prior arts, the self-capacitive touch operation method and the self-capacitive touch sensing apparatus of the invention can selectively combine at least two touch sensing nodes to operate together under different operation modes to largely reduce power consumption of touch sensing and effectively enhance the performance of sensing small touch signals; therefore, the touch signals sensed by the self-capacitive touch operation method and the self-capacitive touch sensing apparatus of the invention can have better signal-to-noise ratio and the sensing performance of the self-capacitive touch operation method and the self-capacitive touch sensing apparatus of the invention can be enhanced accordingly.

The advantage and spirit of the invention may be understood by the following detailed descriptions together with the appended drawings.

### BRIEF DESCRIPTION OF THE APPENDED DRAWINGS

FIG. 1 illustrates a flowchart of the self-capacitive touch operation method in a preferred embodiment of the invention.

FIG. 2 illustrates a functional block diagram of the self-capacitive touch sensing apparatus in another preferred embodiment of the invention.

FIG. 3 illustrates a schematic diagram of six touch sensing nodes A-F.

FIG. 4 and FIG. 5 illustrate schematic diagrams of simulating circuits of combining touch sensing nodes to perform self-capacitive touch sensing and using one touch sensing node to perform self-capacitive touch sensing respectively.

FIG. 6A˜FIG. 6D illustrate timing diagrams of different voltages VS, VP1˜VP2, VCT1˜VCT2 and different currents IL1˜IL2 of FIG. 4 and FIG. 5 respectively.

FIG. 7A and FIG. 7B illustrate schematic diagrams of driving each of the touch sensing nodes A˜D independently and driving the combined touch sensing nodes A˜D under the self-capacitive driving mode respectively.

### DETAILED DESCRIPTION OF THE INVENTION

A preferred embodiment of the invention is a self-capacitive touch operation method. In this embodiment, the self-capacitive touch operation method is applied to a self-capacitive touch panel, and the self-capacitive touch panel can be an in-cell touch panel, an on-cell touch panel or an out-cell touch panel, but not limited to this.

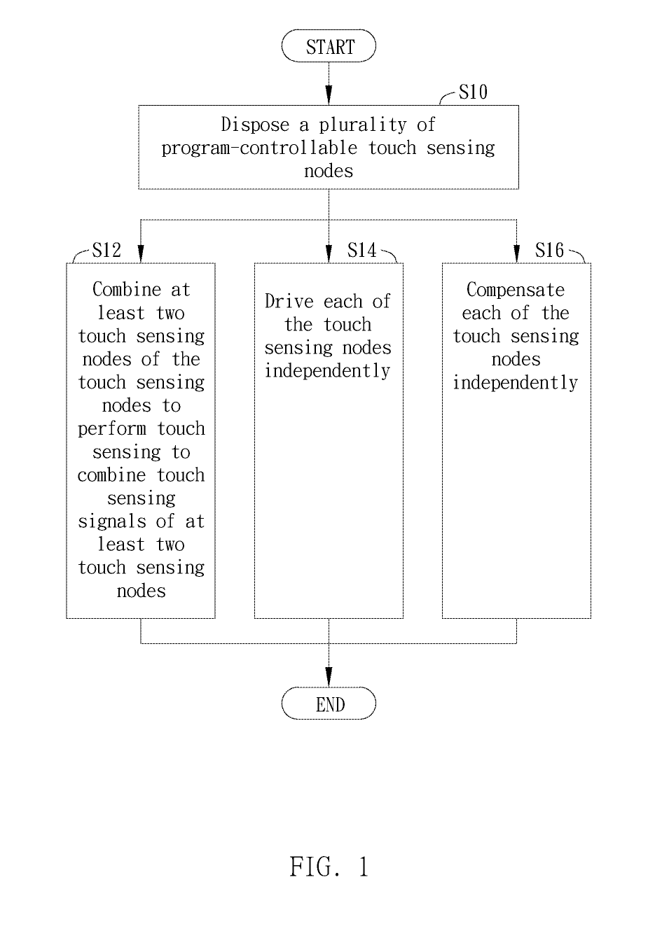

Please refer to FIG. 1. FIG. 1 illustrates a flowchart of the self-capacitive touch operation method in this embodiment. As shown in FIG. 1, in the step S10, the self-capacitive touch operation method disposes a plurality of program-controllable touch sensing nodes.

Then, under different operation modes, the self-capacitive touch operation method selectively controls each of the plurality of touch sensing node to operate independently or combines at least two touch sensing nodes of the touch sensing nodes to operate together.

Embodiments of different operation modes will be introduced as follows.

(1) Under the self-capacitive sensing mode, the self-capacitive touch operation method performs the step S12 to combine the at least two touch sensing nodes of the plurality of touch sensing nodes to perform touch sensing to combine touch sensing signals of the at least two touch sensing nodes. If the touch sensing signals of the at least two touch sensing nodes are small signals, the touch sensing signals are combined as a combined touch sensing signal and then an analog-digital converter calculates a capacitance variation of the combined touch sensing signal to increase signal-to-noise ratio (SNR) and reduce power consumption.

(2) Under a self-capacitive driving mode, the self-capacitive touch operation method performs the step S14 to drive each of the plurality of touch sensing nodes independently.

(3) Under a self-capacitive compensating mode, the self-capacitive touch operation method f performs the step S16 to compensate each of the plurality of touch sensing nodes independently.

Another embodiment of the invention is a self-capacitive touch sensing apparatus. In this embodiment, the self-capacitive touch sensing apparatus is applied to a self-capacitive touch panel, and the self-capacitive touch panel can be an in-cell touch panel, an on-cell touch panel or an out-cell touch panel, but not limited to this.

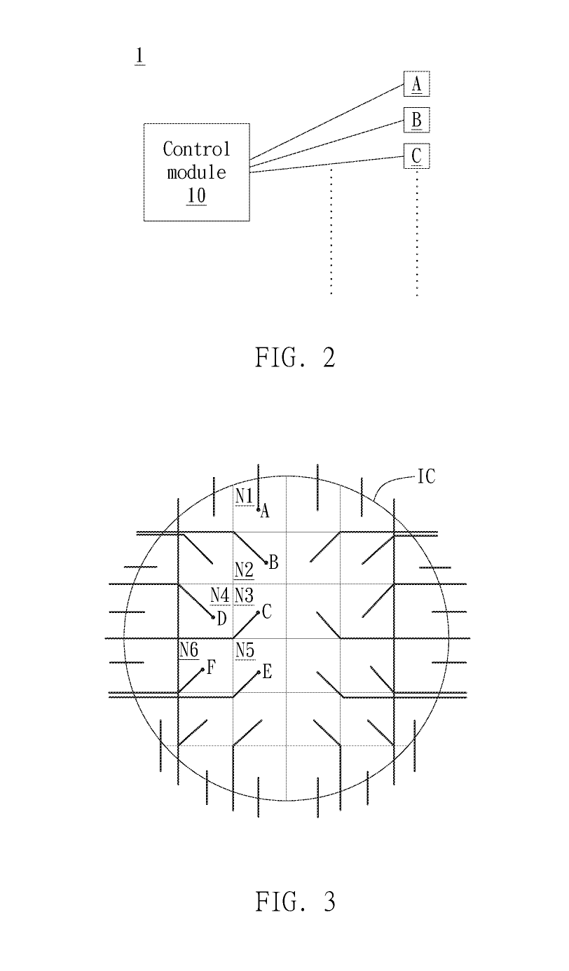

Please refer to FIG. 2. FIG. 2 illustrates a functional block diagram of the self-capacitive touch sensing apparatus in another preferred embodiment of the invention. As shown in FIG. 2, the self-capacitive touch sensing apparatus 1 includes a control module 10 and a plurality of program-controllable touch sensing nodes A, B, C, . . . . The control module 10 is coupled to the plurality of program-controllable touch sensing nodes A, B,

It should be noticed that the self-capacitive touch sensing apparatus 1 can have different operation modes such as the self-capacitive sensing mode, the self-capacitive driving mode and the self-capacitive compensation mode, but not limited to this. Under different operation modes, the control module 10 will selectively control each of the plurality of touch sensing nodes A, B, C, . . . to operate independently or combine at least two touch sensing nodes of the plurality of touch sensing nodes A, B, C, . . . to operate together.

For example, as shown in FIG. 3, it is assumed that the touch sensing nodes A˜F of the self-capacitive touch sensing apparatus 1 are coupled to different areas N1˜N6 of the chip IC respectively and used to perform self-capacitive touch sensing on the different areas N1˜N6 of the chip IC respectively. When the self-capacitive touch sensing apparatus 1 is operated in the self-capacitive sensing mode, the control module 10 will combine at least two touch sensing nodes (e.g., the touch sensing nodes A and B) of the touch sensing nodes A˜F to perform self-capacitive touch sensing on the self-capacitive touch panel to combine the touch sensing signals of the at least two touch sensing nodes.

If the touch sensing signals are small signals (namely having small capacitance variation), the control module 10 will combine the touch sensing signals of the at least two touch sensing nodes as a combined touch sensing signal to increase the capacitance variation and the signal-to-noise ratio (SNR).

TABLE 1

| | | | |
|---|---|---|---|
| Number of combined touch sensing nodes | 1 | 2 | 6 |
| Capacitance variation caused by touch of a finger | 0.6 | 0.8 | 1 |
| Capacitance variation caused by touch of a finger | 0.04 | 0.08 | 0.24 |
| wearing a glove having a thickness of 3 mm | | | |

In practical applications, as shown in Table 1, if one touch sensing node (e.g., the touch sensing node A) is used to perform touch sensing as the prior art, when a finger directly touches the self-capacitive touch panel, the capacitance variation (0.6) sensed by the touch sensing node is still large enough to distinguish from noise; however, if a finger wearing a glove having a thickness of 3 mm touches the self-capacitive touch panel, the capacitance variation (0.04) sensed by the touch sensing node is too small to distinguish from noise and the signal-to-noise ratio of the touch sensing signal will become poor.

When the self-capacitive touch sensing apparatus 1 of the invention is used to perform touch sensing on the self-capacitive touch panel, the self-capacitive touch sensing apparatus 1 of the invention is operated in the self-capacitive sensing mode; therefore, the control module 10 can combine two touch sensing nodes (e.g., A and B) of the touch sensing nodes A˜F to perform self-capacitive touch sensing on the self-capacitive touch panel to combine the touch sensing signals of the two touch sensing nodes (e.g., A and B). At this time, if a finger directly touches the self-capacitive touch panel, the capacitance variation sensed by the combined touch sensing nodes (e.g., A and B) will be increased from 0.6 of the prior art to 0.8 which is large enough to distinguish from noise; it is more important that if a finger wearing a glove having a thickness of 3 mm touches the self-capacitive touch panel, the capacitance variation sensed by the combined touch sensing nodes (e.g., A and B) will be also increased from 0.04 to 0.08.

In order to sense more capacitance variation, the control module 10 can combine more touch sensing nodes (e.g., six touch sensing nodes A˜F) to perform self-capacitive touch sensing on the self-capacitive touch panel to combine the touch sensing signals of the six touch sensing nodes A˜F. At this time, if a finger directly touches the self-capacitive touch panel, the capacitance variation sensed by the combined touch sensing nodes (e.g., six touch sensing nodes A˜F) will be increased to 1; if a finger wearing a glove having a thickness of 3 mm touches the self-capacitive touch panel, the capacitance variation sensed by the combined touch sensing nodes (e.g., six touch sensing nodes A˜F) will be also increased to 0.24. Therefore, the signal-to-noise ratio of the touch sensing signal can be effectively increased.

In addition, when the self-capacitive touch panel is operated in the idle mode or the wake-up mode, the self-capacitive touch sensing apparatus 1 only needs to sense whether the self-capacitive touch panel is touch or not; therefore, the control module 10 can combine multiple touch sensing nodes to perform touch sensing to effectively reduce the power consumption of the self-capacitive touch sensing apparatus 1.

TABLE 2

| | | | |
|---|---|---|---|
| Number of combined touch sensing nodes | 1 | 2 | 6 |
| Power consumption of self-capacitive touch sensing | 100 | 81 | 68 |
| apparatus when self-capacitive touch panel is operated | | | |
| in idle mode (uW) | | | |
| Power consumption of self-capacitive touch sensing | 50 | 44 | 41 |
| apparatus when self-capacitive touch panel is operated | | | |
| in wake-up mode (uW) | | | |

For example, as shown in Table 2, when the self-capacitive touch panel is operated in the idle mode, if one touch sensing node is used to perform touch sensing as the prior art, the power consumption of the self-capacitive touch sensing apparatus 1 is 100 uW. When the self-capacitive touch sensing apparatus 1 of the invention is used to perform touch sensing on the self-capacitive touch panel, the control module 10 can combine two touch sensing nodes (e.g., C and D) of the touch sensing nodes A˜F to perform self-capacitive touch sensing on the self-capacitive touch panel, and the power consumption of the self-capacitive touch sensing apparatus 1 will be reduced to 81 uW. In order to sense more capacitance variation, the control module 10 can combine more touch sensing nodes (e.g., A˜F) to perform self-capacitive touch sensing on the self-capacitive touch panel, so that the power consumption of the self-capacitive touch sensing apparatus 1 can be further reduced to 68 uW.

Similarly, when the self-capacitive touch panel is operated in the wake-up mode, if one touch sensing node is used to perform touch sensing as the prior art, the power consumption of the self-capacitive touch sensing apparatus 1 is 50 uW.

When the self-capacitive touch sensing apparatus 1 of the invention is used to perform touch sensing on the self-capacitive touch panel, the control module 10 can combine two touch sensing nodes (e.g., E and F) of the touch sensing nodes A˜F to perform self-capacitive touch sensing on the self-capacitive touch panel, and the power consumption of the self-capacitive touch sensing apparatus 1 will be reduced to 44 uW. In order to sense more capacitance variation, the control module 10 can combine more touch sensing nodes (e.g., A˜F) to perform self-capacitive touch sensing on the self-capacitive touch panel, so that the power consumption of the self-capacitive touch sensing apparatus 1 can be further reduced to 41 uW.

From the above-mentioned embodiments, it can be found that under low power requirements, the control module 10 can combine the touch sensing signals of at least two touch sensing nodes as a combined touch sensing signal and then an analog-digital converter will calculate a capacitance variation of the combined touch sensing signal to reduce the power consumption of the analog-digital converter. In addition, it can be found that the data amount processed by the backend digital signal processor will be inversely proportional to the number of the combined sensing nodes; therefore, the sensing nodes combined to perform self-capacitive touch sensing in the invention can also reduce the power consumption of the backend digital signal processor.

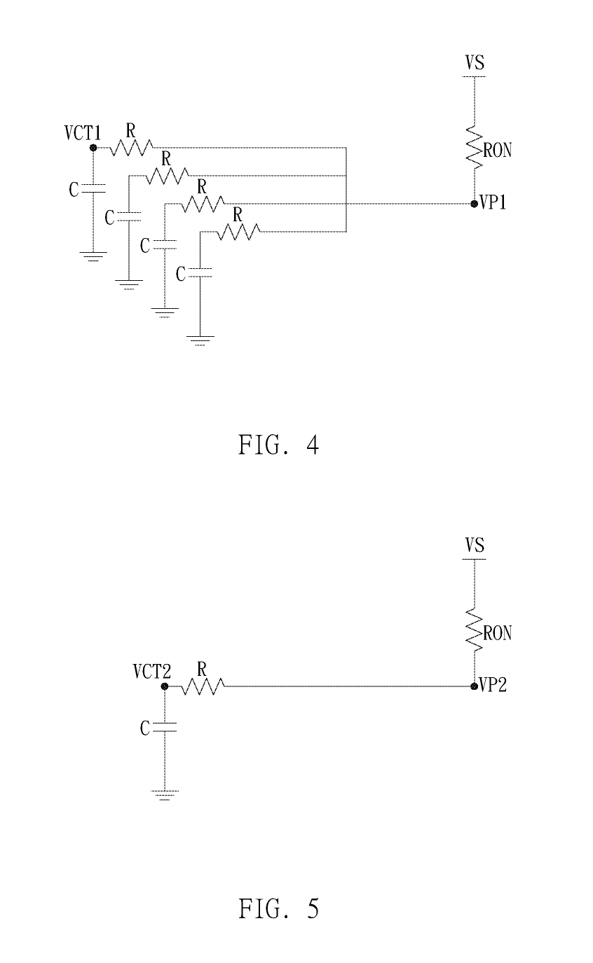

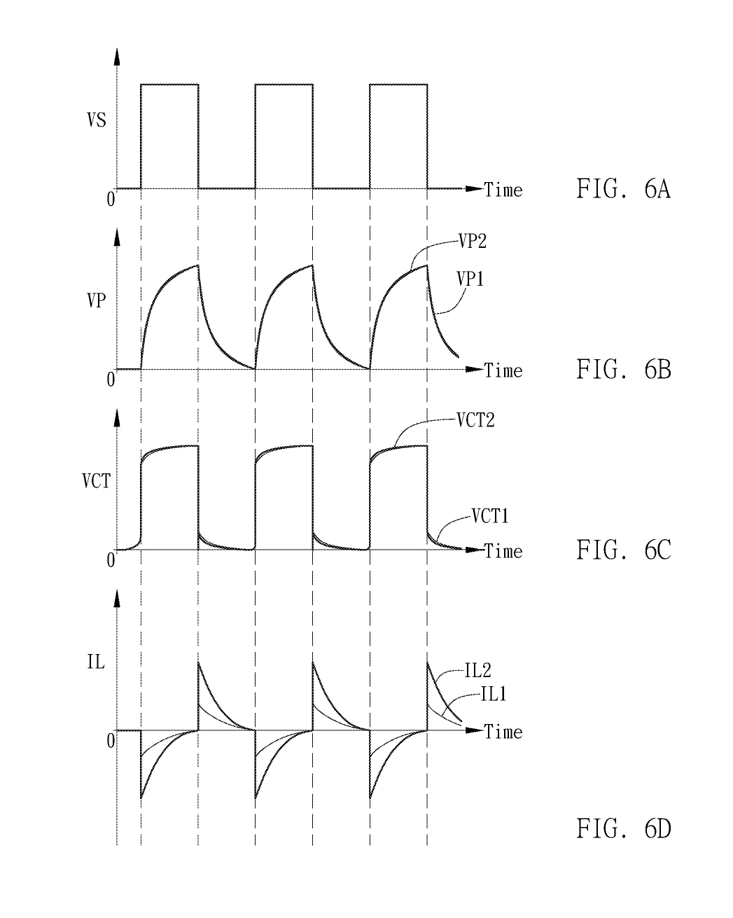

Then, please refer to FIG. 4 and FIG. 5. FIG. 4 and FIG. 5 illustrate schematic diagrams of simulating circuits of combining touch sensing nodes to perform self-capacitive touch sensing and using one touch sensing node to perform self-capacitive touch sensing respectively.

As shown in FIG. 4, in the simulating circuit of combining touch sensing nodes to perform self-capacitive touch sensing, the resistor RON is disposed between the voltage VS and the voltage VP1, and multiple sets of resistor R and capacitor C connected in series are coupled in parallel between the voltage VP1 and the ground terminal. The multiple sets of resistor R and capacitor C connected in series are all the same. The voltage between each set of resistor R and capacitor C connected in series is VCT1.

As shown in FIG. 5, in the simulating circuit of using one touch sensing node to perform self-capacitive touch sensing respectively, the resistor RON is disposed between the voltage VS and the voltage VP2, and one set of resistor R and capacitor C connected in series is coupled between the voltage VP2 and the ground terminal. The voltage between the set of resistor R and capacitor C connected in series is VCT2.

Please refer to FIG. 6A˜FIG. 6D. FIG. 6A˜FIG. 6D illustrate timing diagrams of different voltages VS, VP1˜VP2, VCT1˜VCT2 and different currents IL1˜IL2 of FIG. 4 and FIG. 5 respectively. From FIG. 6A˜FIG. 6D, it can be found that compared to the conventional method using one touch sensing node to perform self-capacitive touch sensing in the prior art, the method combining multiple touch sensing nodes to perform self-capacitive touch sensing in the invention will not increase requirement of RC time constant.

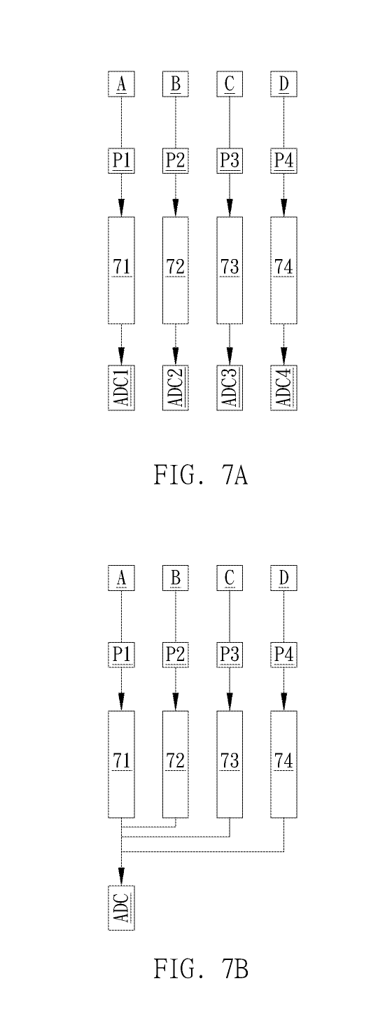

Then, please refer to FIG. 7A and FIG. 7B. FIG. 7A and FIG. 7B illustrate schematic diagrams of driving each of the touch sensing nodes A˜D independently and driving the combined touch sensing nodes A˜D under the self-capacitive driving mode respectively.

As shown in FIG. 7A, each of the touch sensing nodes A˜D is coupled to different analog-to-digital converting circuits ADC1˜ADC4 through the sensing pads P1˜P4 and the analog front-end (AFE) and compensation circuit 71˜74 respectively, so that each of the touch sensing nodes A˜D is driven independently.

As shown in FIG. 7B, each of the touch sensing nodes A˜D is coupled to the same analog-to-digital converting circuit ADC through the sensing pads P1˜P4 and the analog front-end (AFE) and compensation circuit 71˜74 respectively, so that the touch sensing nodes A˜D are combined to be driven together.

It should be noticed that the circuit coupling ways shown in FIG. 7A and FIG. 7B are only embodiments of the invention. In fact, other circuit coupling ways can be also used in the invention, but not limited to this.

Compared to the prior arts, the self-capacitive touch operation method and the self-capacitive touch sensing apparatus of the invention can selectively combine at least two touch sensing nodes to operate together under different operation modes to largely reduce power consumption of touch sensing and effectively enhance the performance of sensing small touch signals; therefore, the touch signals sensed by the self-capacitive touch operation method and the self-capacitive touch sensing apparatus of the invention can have better signal-to-noise ratio and the sensing performance of the self-capacitive touch operation method and the self-capacitive touch sensing apparatus of the invention can be enhanced accordingly.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims. What is claimed is:

1. A self-capacitive touch operation method, applied to a self-capacitive touch panel, comprising steps of:
disposing a plurality of program-controllable touch sensing nodes; and
selectively controlling each of the plurality of touch sensing nodes to operate independently or combining at least two touch sensing nodes of the plurality of touch sensing nodes to operate together under different operation modes.

2. The self-capacitive touch operation method of claim 1, further comprising a step of:
combining the at least two touch sensing nodes of the plurality of touch sensing nodes to perform touch sensing under a self-capacitive sensing mode to combine touch sensing signals of the at least two touch sensing nodes.

3. The self-capacitive touch operation method of claim 2, wherein if the touch sensing signals of the at least two touch sensing nodes are small signals, the touch sensing signals are combined as a combined touch sensing signal and then an analog-digital converter calculates a capacitance variation of the combined touch sensing signal to increase signal-to-noise ratio (SNR) and reduce power consumption.

4. The self-capacitive touch operation method of claim 1, further comprising a step of:
driving each of the plurality of touch sensing nodes independently under a self-capacitive driving mode.

5. The self-capacitive touch operation method of claim 1, further comprising a step of:
compensating each of the plurality of touch sensing nodes independently under a self-capacitive compensating mode.

6. The self-capacitive touch operation method of claim 1, wherein the self-capacitive touch panel is an in-cell touch panel, an on-cell touch panel or an out-cell touch panel.

7. A self-capacitive touch sensing apparatus applied to a self-capacitive touch panel, the self-capacitive touch sensing apparatus comprising:
a plurality of program-controllable touch sensing nodes; and
a control module coupled to the plurality of program-controllable touch sensing nodes, wherein under different operation modes, the control module selectively controls each of the plurality of touch sensing nodes to operate independently or combines at least two touch sensing nodes of the plurality of touch sensing nodes to operate together.

8. The self-capacitive touch sensing apparatus of claim 7, wherein the control module combines the at least two touch sensing nodes of the plurality of touch sensing nodes to perform touch sensing under a self-capacitive sensing mode to combine touch sensing signals of the at least two touch sensing nodes.

9. The self-capacitive touch sensing apparatus of claim 8, wherein if the touch sensing signals of the at least two touch sensing nodes are small signals, the touch sensing signals are combined as a combined touch sensing signal and then an analog-digital converter calculates a capacitance variation of the combined touch sensing signal to increase signal-to-noise ratio (SNR) and reduce power consumption.

10. The self-capacitive touch sensing apparatus of claim 8, wherein under low power requirements, the touch sensing signals are combined as a combined touch sensing signal and then an analog-digital converter calculates a capacitance variation of the combined touch sensing signal to reduce power consumptions of the analog-digital converter and a backend digital signal processor.

11. The self-capacitive touch sensing apparatus of claim 7, wherein under a self-capacitive driving mode, the control module drives each of the plurality of touch sensing nodes independently.

12. The self-capacitive touch sensing apparatus of claim 7, wherein under a self-capacitive compensating mode, the control module compensates each of the plurality of touch sensing nodes independently.

13. The self-capacitive touch sensing apparatus of claim 7, wherein the self-capacitive touch panel is an in-cell touch panel, an on-cell touch panel or an out-cell touch panel.
